(19) United States
(12) Patent Application Publication
(10) Pub. No.: US 2012/0114764 A1
(43) Pub. Date: May 10, 2012

(54) MULTIFUNCTIONAL PRODUCE WASH

(75) Inventors: David H. Creasey, Splendora, TX (US); Barry W. Cummins, Butler, KY (US)

(73) Assignee: Contact Marketing Solutions, LLC, Danbury, CT (US)

(21) Appl. No.: 13/240,341

(22) Filed: Sep. 22, 2011

Related U.S. Application Data
(60) Provisional application No. 61/411,727, filed on Nov. 9, 2010.

(51) Int. Cl. A01N 59/26; B01J 19/08; A23B 7/153; A01P 1/00; B08B 3/04

(52) U.S. Cl. 424/604; 424/605; 134/25.3; 204/164

(57) ABSTRACT

A produce wash is provided that significantly reduces the amount of chlorine used in treating produce and inhibits the growth of micro-organisms on pre-harvest and post-harvest produce. A method of using the produce wash extends the shelf life of harvested produce.

### CROSS-REFERENCE TO RELATED APPLICATIONS

This application claims priority to U.S. Provisional Application No. 61/411,727, which was filed on Nov. 9, 2010, and is incorporated herein by reference in its entirety.

### FIELD OF THE INVENTION

This invention relates to a produce wash for inhibiting the growth of micro-organisms that contaminate produce.

### BACKGROUND OF THE INVENTION

Edible vegetation in the human diet, such as fruit, vegetables, nuts, and crops harvested and handled in contaminated environments, carry the potential for illness and death. Well known pathogens such as Salmonella, Listeria and E. coli, as well as indicator and spoilage organisms, including Staphylococcus bacteria can be found on raw fruit, vegetables, or partially cooked foodstuffs during harvesting and processing.

The globalization of business, travel and communication brings increased attention to worldwide exchanges between communities and countries, including the potential globalization of the bacterial ecosystem. Harmful bacteria were once controlled with antibiotics, such as with penicillin in the mid-1940s, but this control no longer exists as more and more antibiotic resistant bacteria appear around the globe. For example, before 1946 about 90 percent of Staphylococcus aureus isolates in hospitals were susceptible to penicillin, but by 1952, 75 percent of isolates were penicillin-resistant. Bacterial resistance to antimicrobial agents has emerged throughout the world as one of the major threats in both human and veterinary medicine. Resistance to antibiotics and antimicrobial agents has emerged at an alarming rate because of a variety of factors, such as clustering and overcrowding, the increased use of antibiotics in animal culture and aquaculture, an increase in the number of elderly people, increased traveling, the sale of antibiotics over the counter, self-treatment with antibiotics, a lack of resources for infection control, and the inappropriate use of antibiotics.

Thus, the world population is at increased risk for acquiring antimicrobial-resistant food borne infections. Even a small increase in the prevalence of resistance in the most significant pathogenic bacteria may lead to large increases in the potential for treatment failures and other adverse outcomes, including death.

Recent media coverage has highlighted the problem associated with bacterial contamination of raw fruits such as strawberries and raspberries. In 2006, an E. coli outbreak resulted from consumption of contaminated fresh spinach. In the summer of 2008, a salmonella outbreak linked to raw tomatoes was a reminder to take extra care with summer fruits and vegetables. Restaurateurs were asked to “Hold the Tomatoes!”

Salmonella can be transmitted to humans when fecal material from animals or humans contaminates food. Symptoms are similar to the flu, but the poisoning can be fatal to young children, pregnant women and persons with weakened immune systems. Consumers cannot detect salmonella by smell, taste or sight. One precautionary measure is to wash all produce with cold running water to remove sand and/or grit from the field, residual pesticides and bacteria. The recommendation of the Food Safety Institute International is that fruits, except bananas, should be washed even if the peel will not be eaten.

Appropriate use of antimicrobial agents in processing foodstuffs has become necessary to avoid microbial contamination and reduce the potential for the spread of resistant organisms. Chlorine or hydrochloric acid are frequently used as bactericides and are also used universally as cleaning agents. However, one problem with compounds such as chlorine or hydrochloric acid is that they can be toxic to human beings, thereby defeating the purpose of preserving and cleaning the foodstuffs. Often chlorine or hydrochloric acid require special handling as they can cause skin irritation and other side effects, and can even be fatal if accidentally consumed. Chlorine has other negative implications with respect to the environment, in part because of the release of chlorine gas into the environment and the requirement for special disposal methods.

Various methods for treating produce and similar compositions that reduce toxins and contamination of foodstuffs have been proposed. For example, U.S. Pat. No. 5,551,461 discloses a produce washer which resembles a dishwasher for vegetables and fruit. Produce is loaded into a basket of mesh material placed in a closeable cabinet. A washing fluid that is slightly acidic is applied, followed by a rinsing fluid, such as tap water. U.S. Pat. No. 6,506,737 discloses an antimicrobial composition for the food industry that may include sulfuric acid, sulfates and an ammonium halide salt to provide a gel-thickened compound for cleaning and sanitizing surfaces for food preparation. The inclusion of a halide in this composition limits uses involving ingestion by man or animals and would be deleterious to machinery, plants and other vegetation. U.S. Pat. No. 6,537,600 describes mobile systems for cleaning and drying produce in order to extend shelf life. Electrical energy and mechanical energy, such as ultrasonic energy are employed to destroy or transform pathogens, dirt and synthetic molecules present on the produce. U.S. Pat. No. 7,163,709 describes an ingestible disinfectant to eradicate and control pathogens on plants, animals, humans, byproducts of plants and animals, and articles infected with pathogens. The disinfectant includes sulfuric acid, water and metallic ions, particularly copper, silver and gold. In U.S. Pat. Nos. 5,989,595 and 6,242,011 to Cummins, an acidic composition of matter is disclosed that is useful for destroying microorganisms that spoil food, such as fish.

However, each of these disclosed methods has drawbacks and a need remains for a composition that is stable over a wide range of temperatures, minimizes the use of chlorine, extends the shelf-life of harvested produce, and is effective in destroying contaminants on both pre-harvest and post-harvest produce.

### SUMMARY OF THE INVENTION

A concentrated produce wash for pre-harvest and post-harvest treatment of produce is provided. The concentrated produce wash is prepared by the steps comprising:

(a) preparing a non-irritating acid component by the steps comprising
(i) selecting at least one of sulfuric acid, phosphoric acid, fumaric acid and acetic acid in a purity of approximately 98%;
(ii) combining the selected acid in a 1 to 2 volume ratio with distilled water and a metallic sulfate mixture selected from at least two of sodium sulfate, magnesium sulfate, zinc sulfate, manganese sulfate and copper sulfate in a ratio of from approximately 1 to approximately 5 pounds of sulfate compound per gallon of distilled water to provide a first mixture;
(iii) combining the first mixture in a pressurized vessel at a pressure that is approximately 15 psi above atmospheric pressure;
(iv) heating the first mixture at a temperature in a range between approximately 200° F. and approximately 1200° F., for at least 30 minutes to form a second mixture;
(v) cooling the second mixture;
(vi) adding a stabilizer which comprises 10 weight percent of the total weight of the first mixture of step ii to provide a stable, non-irritating acidic component having a pH of approximately 2; and

(b) mixing the stable, non-irritating acidic component with chlorine to form a concentrated produce wash solution.

Further provided are methods for using the produce wash to remove contaminants from produce. The methods comprise diluting the concentrated produce wash and applying diluted produce wash to pre-harvest or post-harvest produce by at least one of a spray, mist, fog, and vapor, or dipping, soaking, washing, and/or rinsing the produce in the diluted produce wash. The produce wash may also be applied to the produce as crushed ice.

### DETAILED DESCRIPTION OF THE INVENTION

A novel produce wash composition that is safe and effective in both pre-harvest and post-harvest applications and is friendly to the environment is described. The produce wash reduces the concentration of micro-organisms on produce and extends the shelf life of harvested produce. In addition to removing micro-organisms, the produce wash also removes sand and grit from the field and residual pesticides.

Certain terms used herein are defined as follows:

“Produce” refers to any edible vegetation, e.g., fruits (including vegetable fruits), herbs, leaves, stems, roots, flowers and seeds of plants, as well as edible fungi.

“Pre-harvest” refers to any time after seed germination and before the cessation of growth of a plant product or the life of a plant.

“Post-harvest” refers to any time after the cessation of growth of a plant product or life of a plant, and includes non-food hard surfaces used in processing and preparing foodstuffs.

“Acidic component” is a combination of an acid, metallic sulfates and water heated in a pressurized vessel, cooled and stabilized to form a non-irritating low pH material generally as described in U.S. Pat. No. 8,012,511, which is incorporated in entirety herein by reference.

“E. coli” refers to Escherichia coli, an indicator bacterial species.

“Listeria” refers to Listeria monocytogenes, a pathogen.

“Pseudomonas” refers to Pseudomonas fluorescens, a spoilage bacterial species.

“Salmonella” refers to Salmonella typhimurium, a pathogen.

“Shewanella” refers to Shewanella putrefaciens, a spoilage bacterial species.

“Staph” refers to Staphylococcus aureus, a pathogen.

The produce wash composition has three distinct components: (1) an acidic component that is not an irritant, (2) chlorine, and (3) water. These three components are mixed at room temperature to prepare the produce wash. To prepare the first component of the composition, i.e., an acidic component that is not an irritant, a pressurized vessel that includes a cooling jacket is selected. A preferred pressurized vessel is fitted with two electrodes, a cathode and anode, to provide a direct current voltage approximately one foot above the bottom of the vessel. The electrodes are spaced approximately three feet apart. The acidic component is prepared in the pressurized vessel by combining an acid in a 1 to 2 volume ratio with distilled water and a combination of sodium sulfate and copper sulfate in the ratios listed in Table I, to form a first mixture (Mixture I). The acid may be sulfuric acid, phosphoric acid, fumaric acid or acetic acid with purity in a range of approximately 98% to approximately 99.9%.

TABLE I
Use Levels in Milliliters per Gallon (ml/gal)

| Ratio of sulfate compounds | Range | Target |
|---|---|---|
| Sodium sulfate | 1.0 to 5.0 ml/gal | 3.0 ml/gal |
| Copper sulfate | 0.5 to 4.0 ml/gal | 1.0 ml/gal |

During the addition of sodium sulfate and copper sulfate, a direct current voltage may optionally be applied to the mixture. The voltage is applied in a range from approximately one (1) amp to approximately 100 amps, preferably between approximately 1 amp and approximately 5 amps. The mixture is then heated under pressure in a range of from approximately 1 pound per square inch (psi) to approximately 15 psi above atmospheric pressure. The mixture is heated at a temperature in a range of from approximately 200° F. to approximately 1200° F., preferably from approximately 350° F. to approximately 400° F. for approximately three to four hours, during which time excess hydrogen gas is removed, to form a second mixture. The amounts of temperature, time and pressure are selected and adjusted as necessary to maintain a safe chemical reaction.

After heating, the second mixture is allowed to cool to room temperature. After cool down, an additional amount (10-15 weight percent) of the first mixture is added to the cooled reaction mixture to act as a stabilizer. The resulting acidic mixture (pH between 1-3) is a non-irritating concentrate that is useful for destroying microorganisms.

This acidic component is compatible with chlorine due to the addition of the sulfate compounds. Therefore, smaller amounts of chlorine can be used in the produce wash with greater efficacy than using chlorine alone, thereby avoiding side-effects associated with chlorine use, such as health risks to workers, danger or harm to the environment, and requirements for special disposal methods.

The composition of the produce wash of the present invention is listed in Table II below:

TABLE II
Produce Wash

| Component | Quantity |
|---|---|
| Non-irritating acid | 1 gallon |
| Chlorine | 1-5 ml/gallon |
| | Preferably 1 ml/gallon |
| Water | 2,000 to 3,000 gallons |

One gallon of the non-irritating acid concentrate is combined with 1 to 5 milliliters of chlorine to make approximately 1 gallon of produce wash concentrate. For example, chlorine may be added as sodium hypochlorite or a solution thereof. The produce wash concentrate may easily be transported to remote farming locations and diluted on site with thousands of gallons of water, in a ratio of from approximately 1 gallon of produce wash concentrate to 2,000 to 3,000 gallons of water to make a produce wash for spraying or misting crops. The water used to dilute the produce wash can be from any source of potable drinking water, for example, well water, municipal water sources and desalinated drinking water. The chlorine concentration present in the diluted produce wash is in a range of between 1 to 5 parts per million (ppm), which is a significant reduction compared with traditional chlorine-based washes that contain between 50 to 100 ppm chlorine at the time of application.

The produce wash may be produced in several forms when diluted with distilled water, such as an aerosol, mist, vapor or fog to produce micron-sized particles that remain in suspension in the air for a period of time and act on airborne pathogens that come in contact with the composition. The produce wash may be applied to pre-harvest plants and produce as a spray or mist. The produce wash may be applied post-harvest to plants and edible plant products including, but not limited to fruits (including vegetable fruits), stems, leaves, roots, flowers and seeds. The produce wash may also be applied to edible fungi, such as mushrooms. Post-harvest treatment may be by dipping, washing, soaking, or rinsing the food product by any method that does not bruise or otherwise damage the produce. The composition can also be frozen and applied to harvested produce in the form of crushed ice. The crushed ice form of the produce wash can be used, for example, for shipping vegetables such as broccoli. Micro-organisms killed by the produce wash include, but are not limited to, bacteria such as Salmonella typhimurium, Listeria monocytogenes, Staphylococcus aureus, Escherichia coli, Pseudomonas fluorescens and Shewannella putrefaciens. The produce wash is also effective in rinse and spray streams and chiller or ice packing, and helps to provide a safer, healthier food supply.

### EXAMPLES

### Example 1

### Chlorine Compatibility with the Acidic Component

Tests #1 and #2 in Table III measure changes in chlorine concentration over time in the acidic component prepared with electrolysis and containing 1 ppm copper and 1 or 2 ppm chlorine. These data show that there are no significant reductions in chlorine over a one hour test period. Tests #3 and #4 measure changes in chlorine concentration over time in the acidic component containing 1 ppm copper and 1 or 2 ppm chlorine, but prepared without electrolysis. These data also show that there are no significant reductions in chlorine over the one hour test period.

TABLE III
Chlorine Compatibility Tests of Acidic Component
made with Sodium Sulfate

| Time | Soln 1 | Soln 2 | | Time | Soln 1 | Soln 2 | |
|---|---|---|---|---|---|---|---|
| (min) | (ppm) | (ppm) | | (min) | (ppm) | (ppm) | |
| Test #1 - 1 ppm chlorine, | | | | Test #2 - 2 ppm chlorine, | | | |
| 1 ppm copper | | | | 1 ppm copper | | | |
| Acid, Water, Sodium | | | | Acid, Water, Sodium | | | |
| Sulfate + electrolysis | | | | Sulfate + electrolysis | | | |
| 0 | 1.08 | 1.08 | Starting | 0 | 1.99 | 1.99 | Starting |
| | | | FAC* | | | | FAC* |
| 15 | 1.09 | 1.09 | | 15 | 2.00 | 2.02 | |
| 30 | 1.09 | 1.10 | | 30 | 2.04 | 2.03 | |
| 45 | 1.08 | 1.08 | | 45 | 2.03 | 2.02 | |
| 60 | 1.09 | 1.08 | No | 60 | 2.05 | 2.03 | No |
| | | | Reduction | | | | Reduc- |
| | | | | | | | tion |
| Test #3 - 1 ppm Chlorine, | | | | Test #4 - 2 ppm Chlorine, | | | |
| 1 ppm copper | | | | 1 ppm copper | | | |
| Acid, Water, Sodium | | | | Acid, Water, Sodium | | | |
| Sulfate − No electrolysis | | | | Sulfate − No electrolysis | | | |
| 0 | 1.09 | 1.09 | Starting | 0 | 2.01 | 2.00 | Starting |
| | | | FAC* | | | | FAC* |
| 15 | 1.08 | 1.09 | | 15 | 2.02 | 2.02 | |
| 30 | 1.07 | 1.08 | | 30 | 2.03 | 2.04 | |
| 45 | 1.09 | 1.10 | | 45 | 2.04 | 2.02 | |
| 60 | 1.09 | 1.11 | No | 60 | 2.02 | 2.00 | No |
| | | | Reduction | | | | Reduc- |
| | | | | | | | tion |

*FAC = Free Available Chlorine

These tests show no incompatibility between the low pH acidic composition made with sodium sulfate, copper sulfate and chlorine. Therefore, the composition can be effectively used in conjunction with chlorine to control micro-organisms. These data also demonstrate that electrolysis does not negatively affect compatibility with chlorine.

### Example 2

### Applications for Produce Wash

The efficacy of the produce wash as an antimicrobial agent is suitable for many uses, such as those as exemplified in Table IV. The produce wash may be used on any type of produce and use is not limited to the types of produce listed in these examples.

TABLE IV
Post-Harvest Applications for Produce Wash

| Post-Harvest Application | Application Method | Water Source |
|---|---|---|
| Lettuce | In-field spray | Municipal or well |
| Tomatoes | Plant bath | Municipal or well |
| Cut bag salads | Vat baths | Municipal or well |
| Celery | In-field spray | Municipal or well |
| Spinach | In-field spray | Municipal or well |
| Broccoli | Crushed ice pack | Frozen ice blocks |
| Vegetables | Hydro chillers | Produce wash mist |
| Sweet Bell Peppers | In-field spray | Municipal or well |

Table IV indicates the enormous commercial potential for this novel antimicrobial composition.

### Example 3

### Shelf Life Extension

Standard chlorine wash contains up to about 5,000 ppm chlorine. If more than 5,000 ppm is used, the taste of the chlorine becomes noticeable, which is undesirable for the consumer. In addition, at the 5,000 ppm chlorine, a standard chlorine wash is microstatic, i.e., it inhibits growth of micro-organisms, but does not kill them. Eventually the micro-organisms will begin to reproduce, leading to spoilage.

Reduced TBC (total bacteria count) correlates with expanded shelf life of produce. As shown in Table V, pre-harvest application of the produce wash eliminated bacteria and other contaminants on produce at a very low concentration of chlorine. As a result, shelf life was improved by 50-60% (3-5 days) compared with produce treated with a standard chlorine produce wash.

TABLE V
Shelf Life in Days

| | Produce wash | Chlorine wash |
|---|---|---|
| Pre-Harvest Application | 2 ppm Cl | ≧5000 ppm Cl |
| Lettuce | 8-12 days | 5-7 days |

### Example 4

### Romaine Heart Lettuce Samples—Bacteria Study 33 Days Post-Harvest

Lettuce samples were submitted for analysis by standard test methodology from the Bacteriological Analytical Manual (BAM), U.S. Food and Drug Administration, 11^{th} edition. Results are shown in Table VI. Colony forming units per gram (cfu/g) represent counts of live bacteria or other contaminants after 33 days.

TABLE VI
Romaine Heart Lettuce Samples - Bacteria Study 33 days Post-Harvest

| SAMPLE ID. | RH-1 | TRH-1 |
|---|---|---|
| Aerobic Heterophilic (TPC), cfu/g | 170,000 | 10,000 |
| Fecal Coliforms, cfu/g | 50 | 13 |
| E. coli, cfu/g | 13 | None Detected |
| Staphylococcus, cfu/g | None Detected | None Detected |
| Salmonella/Shigella, cfu/g | None Detected | None Detected |

RH-1 is Romaine Heart Lettuce treated with a standard chlorine wash. TRH-1 is Romaine Heart Lettuce treated with produce wash. These data show that the produce wash caused significant reductions in contaminants, i.e., a 17-fold reduction in Aerobic Heterophilic total plate count (TPC), colony forming units per gram (cfu/g) compared with a standard chlorine wash.

### Example 5

### Green Leaf Lettuce Samples 33 Days Post-Harvest

Chopped Green Leaf Lettuce (CHL) was treated with standard chlorine wash. Chopped and Bagged (T-bag) Green Leaf Lettuce was treated with produce wash. The effect of these treatments on bacterial counts are shown in Table VII. Produce wash caused significant reductions in all contaminants, with a 91-fold reduction in Aerobic Heterophilic (TPC), cfu/g when compared with treatment with a standard chlorine wash.

TABLE VII
Green Leaf Lettuce Samples 33 days Post-Harvest

| SAMPLE ID. | CGL-1 | T-Bag |
|---|---|---|
| Aerobic Heterophilic (TPC), cfu/g | 1,280,000 | 14,000 |
| Fecal Coliforms, cfu/g | ≧1600 | None Detected |
| E. coli, cfu/g | 53 | None Detected |
| Staphylococcus, cfu/g | 80 | None Detected |
| Salmonella/Shigella, cfu/g | 4 | None Detected |

### Example 6

### Iceberg Lettuce Samples 33 Days Post-Harvest

Iceberg Lettuce was treated with standard chlorine wash (C-IB1) or with produce wash (T-IB1) 33 days after harvest. Table VIII shows that produce wash caused significant reductions in all contaminants, with a 15-fold reduction in Aerobic Heterophilic (TPC), cfu/g when compared to iceberg lettuce washed with a standard chlorine wash.

TABLE VIII
Iceberg Lettuce Samples 33 days Post-Harvest

| SAMPLE ID. | C-IBI | T-IB1 |
|---|---|---|
| Aerobic Heterophilic (TPC), cfu/g | 600,000 | 40,000 |
| Fecal Coliforms, cfu/g | ≧1600 | 13 |
| E. coli, cfu/g | 93 | 2 |
| Staphylococcus, cfu/g | 23 | 2 |
| Salmonella/Shigella, cfu/g | None Detected | None Detected |

Although the invention is illustrated and described herein with reference to specific embodiments, the invention is not intended to be limited to the details shown. Various modifications may be made in the details within the scope and range of equivalents of the claims and without departing from the invention.

We claim:

1. A concentrated produce wash for pre-harvest and post-harvest treatment of produce produced by the steps comprising:
(a) preparing a non-irritating acid component by the steps comprising
(i) selecting at least one of sulfuric acid, phosphoric acid, fumaric acid and acetic acid in a purity of approximately 98%;
(ii) combining the selected acid in a 1 to 2 volume ratio with distilled water and a metallic sulfate mixture selected from at least two of sodium sulfate, magnesium sulfate, zinc sulfate, manganese sulfate and copper sulfate in a ratio of from approximately 1 to approximately 5 pounds of sulfate compound per gallon of distilled water to provide a first mixture;
(iii) combining the first mixture in a pressurized vessel at a pressure that is approximately 15 psi above atmospheric pressure;
(iv) heating the first mixture at a temperature in a range between approximately 200° F. and approximately 1200° F., for at least 30 minutes to form a second mixture;
(v) cooling the second mixture;
(vi) adding a stabilizer which comprises 10 weight percent of the total weight of the first mixture of step ii to provide a stable, non-irritating acidic component having a pH of approximately 2; and
(b) mixing the stable, non-irritating acidic component with chlorine to form a concentrated produce wash solution.

2. A dilute produce wash for pre-harvest and post-harvest treatment of produce, prepared by combining the concentrated produce wash of claim 1 with water in a ratio of 1 gallon of concentrated produce wash to approximately 2000-3000 gallons of potable water.

3. The produce wash of claim 1, further comprising applying direct current voltage to the acid while combining the sulfates with the acid in step (ii).

4. The produce wash of claim 3, wherein the direct current voltage is in a range from approximately 1 amp to approximately 100 amps.

5. The produce wash of claim 4, wherein the direct current voltage is in a range from approximately 1 amp to approximately 5 amps.

6. A method for removing contaminants and killing micro-organisms on pre-harvest or post-harvest produce comprising applying the dilute produce wash of claim 2 to pre-harvest or post-harvest produce.

7. The method of claim 6, wherein the dilute produce wash is applied as at least one of a spray, mist, fog, or vapor in the field where the produce is grown.

8. The method of claim 6, wherein the dilute produce wash is applied by at least one of dipping, soaking, washing, and rinsing the produce in the dilute produce wash.

9. The method of claim 6, wherein the produce wash is frozen to form an ice, crushed, and applied to post-harvest produce.

10. The method of claim 9, wherein the produce wash in the form of crushed ice is layered over post-harvest produce during shipping.

11. The method of claim 6, wherein the micro-organisms killed by the dilute produce wash are selected from the group consisting of Salmonella typhimurium, Listeria monocytogenes, Staphylococcus aureus, Escherichia coli, Pseudomonas fluorescens and Shewannella putrefaciens.

12. The method of claim 6, wherein the treated produce has an extended shelf life of from 1 to 5 days longer than produce that is not treated with the dilute produce wash.

13. A method of inhibiting growth of known pathogenic, indicator and spoilage bacteria during pre-harvest and post-harvest treatment of produce, comprising the steps of
(a) preparing a produce wash concentrate comprising the process of
(i) selecting at least one of sulfuric acid, phosphoric acid, fumaric acid and acetic acid in a purity of approximately 98%;
(ii) combining the acid in a 1 to 2 volume ratio with distilled water and a metallic sulfate mixture selected from at least two of sodium sulfate, magnesium sulfate, zinc sulfate, manganese sulfate and copper sulfate in a ratio of from approximately 1 to approximately 5 pounds of sulfate compounds per gallon of distilled water to provide mixture (I);
(iii) combining the mixture (I) in a pressurized vessel at a pressure that is approximately 15 psi above atmospheric pressure;
(iv) heating the mixture at a temperature in a range between approximately 200° F. and approximately 1200° F., for at least 30 minutes to form mixture (II);
(v) cooling the mixture (II);
(vi) adding a stabilizer which comprises 10 weight percent of the total weight of mixture (I), thereby forming mixture (III); and
(vii) providing a stable, non-irritating acid component having a pH value of approximately 2.
(b) mixing the non-irritating acid component with chlorine to form mixture A;
(c) diluting the mixture A with water in a ratio of 1 part mixture A to 2000 parts water to form a produce wash; and
(f) applying the produce wash to produce.

14. The method of claim 13, wherein the produce wash is applied to produce growing in a field pre-harvest by at least one of spraying and misting.

15. The method of claim 13, wherein the produce wash is applied to produce post-harvest by at least one of dipping, soaking, washing and rinsing.

16. The method of claim 13, wherein the produce wash is frozen to form an ice, the ice is crushed and is applied to produce post-harvest by layering with the crushed produce wash ice.

17. The method of claim 16, wherein the crushed produce wash ice is applied to post-harvest broccoli.
